(19) United States
(12) Patent Application Publication
(10) Pub. No.: US 2007/0127807 A1
(43) Pub. Date: Jun. 7, 2007

(54) Defect inspection method, defect inspection system, defect inspection program, and memory medium with that program memorized in it

(75) Inventor: Kazunori Koshikawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AVIS CORPORATION, Chigasaki-City (JP)

(21) Appl. No.: 11/542,375

(22) Filed: Oct. 4, 2006

(30) Foreign Application Priority Data
Dec. 6, 2005 (JP) 2005-352162
May 12, 2006 (JP) 2006-134060

(51) Int. Cl. G06K 9/00

(52) U.S. Cl. 382/149

(57) ABSTRACT

The object of the invention is to provide a defect inspection method, a defect inspection system, and a defect inspection program, in which the inspection time for the object to be inspected and identifiable as a linear or band-like one is so very short that the operation time and tact time can be cut down, and which prevents misidentification even when there is distortion or deformation in the object, thereby making precise defect inspection possible. In the defect inspection method, system and program, the luminance and the number of pixels in the widthwise direction of the image of the object to be inspected such as the edge portion of a semiconductor wafer, wherein the image is identifiable as a linear or band-like one, are summated up, and the object is determined as defective when the value of the summation is below a reference value.

### BACKGROUND OF THE INVENTION

1. Art Field

The present invention relates to a defect inspection method, a defect inspection system and a defect inspection program, all adapted to detect defects such as flaws, stains, dusts, and cracks in and on, for instance, the outer peripheries of semiconductor wafers (hereinafter called the wafer edges), the outer peripheries of disks such as hard disks, and electric wires, optical fibers, etc. which are imaged in a linear form.

2. Background Art

Generally, defect inspection is carried out, for instance, at the time of supplying industrial products to the market or passing them into another process for removal of defective products. For instance, in semiconductor fabrication processes, defect inspection is performed for each fabrication step.

A main object of this defect inspection is to make inspection of defects such as flaws and cracks on the surfaces of, for instance, semiconductor wafers as well as dusts and stains deposited on them. More recently, the observation of the amount, distribution, etc. of the wafer edge to be cut, too, has been in demand. In particular, the presence of cracks on a wafer edge portion will often cause the wafer to crack apart. It is thus required that at an earlier stage, inspection be made of whether or not there is a crack at a wafer edge portion, thereby sorting out defective wafers.

When it comes to a wafer edge portion, a thin film of photoresist is coated on the surface of a wafer, and a suitable amount of rinse solution is then added down onto the thin film to cut the photoresist by a given width. Detection of the cut width of the photoresist here, too, is an important check point for implementing the subsequent steps well to fabricate semiconductor wafers of good quality.

Referring to the techniques of inspecting wafer edge portions, for instance, JP-A 9-269298 sets forth a method of directing parallel light collected with an elliptic mirror to the edge portion of a wafer, and collecting diffracted light of higher dimension out of the ensuing diffracted light using an elliptic mirror while diffracted light of lower dimension is blocked off, so that defects in and on, and the properties of, the wafer edge portion can be identified from the intensity and/or frequency components of that diffracted light. In addition, there is a technique of inspecting a wafer edge portion with at least one video camera, wherein infrared laser beams are directed to the wafer edge portion while the wafer has a tilt to the laser beams, as set forth in JP-A 2000-136916.

However, both methods of these publications are not designed to detect defects at the wafer edge portion, especially the edge cut line width, although they may be used to detect the wafer edge portion. For this reason, it is difficult to apply them to rejects detection operation at the steps subsequent to the photoresist thin film coating.

Another requirement for defect inspection is that image data (an edge image) about the full periphery of a wafer be obtained for estimation. However, each of those techniques renders detection of defects all around the periphery of the edge portion difficult, because it is not designed to pick up the edge image all around the periphery.

To solve such problems, for instance, domestic re-publication of PCT No. 03/028089 has come up with a method for implementing inspection of the outer periphery of a semiconductor wafer at a semiconductor fabrication/inspection step. With the method disclosed there, determination is made through the comparison of the obtained band-like image with image data on a good quality wafer. However, computation of enormous volumes of data must be implemented for such image data comparison, and some considerable amount of processing time would be taken even with a recently developed faster processor. Much inspection time is thus required relative to such a simple appearance inspection, offering an obstacle to cutting down the operating time and tact time in semiconductor fabrication processes.

Even with a conventional method, when an edge area is linear as shown typically in FIG. 5, a defect d found at an edge area held between edge ends e1 and e2 can be detected somehow with no problem. However, as there is distortion or deformation at the edge area to be inspected as shown in FIG. 6, there are vibrations such as waves or undulations occurring in the picked-up image. As that edge area is processed with such a conventional method as mentioned above, there is a risk that this vibrating portion m might be perceived as a sort of defect. On the other hand, the influences of that vibrating portion may be reduced or eliminated by filtering, but this time even the defective portion is eliminated out, resulting in a considerable drop of inspection capability.

### SUMMARY OF THE INVENTION

One object of the present invention is to provide a defect inspection method, a defect inspection system, and a defect inspection program, which enables an inspection time to be so very short that the operating time and tact time can be cut down, and in which the image of the object to be inspected is identifiable as a linear or band-like one.

Another object of the present invention is to provide a defect inspection method, a defect inspection system, and a defect inspection program, which prevents misidentification of the object to be inspected even when there is distortion or deformation, and can make precise defect inspection possible.

### MEANS FOR ACHIEVING THE OBJECTS

That is, the above objects are achievable by the inventions as embodied below.

(1) A defect inspection method, comprising summation of a luminance and a number of pixels in a widthwise direction of an image of an object to be inspected, said image being identifiable as a linear or band-like one, wherein said object is determined as defective when a value of said summation is below a reference value.

(2) The defect inspection method according to (1) above, wherein said object is an end of a disk.

(3) A defect inspection system, wherein an image of an object to be inspected, which is identifiable as a linear or band-like one, is picked up, and a luminance and a number of pixels of the obtained image in a widthwise direction are summated up, so that said object is determined as defective when a value of said summation is below a given reference value.

(4) A defect inspection program, which is adapted to implement processing comprising summation of a widthwise luminance and a widthwise number of pixels from image data about an object to be inspected, said object being identifiable as a linear or band-like one, wherein said object is determined as defective when a value of said summation is below a given reference value.

(5) A memory medium, wherein the defect inspection program according to (4) above is memorized.

### BRIEF DESCRIPTION OF THE DRAWINGS

FIG. 1 is illustrative of the principles of the present invention.

FIG. 2 is a flowchart indicative of the processing according to the present invention.

FIG. 3 is a flowchart indicative of how to find a threshold value by computation.

FIG. 4 is a block diagram illustrative of one embodiment of the system fit for carrying out the present invention.

FIG. 5 is illustrative in schematic of how prior art defect inspection processing is implemented.

FIG. 6 is illustrative in schematic of how prior art defect inspection processing is implemented.

FIG. 7 is illustrative in schematic of how prior art defect inspection processing is implemented.

### EXPLANATION OF THE PREFERRED EMBODIMENTS

The defect inspection method of the present invention involves summation of the luminance and the number of pixels in the widthwise direction of the image of the object to be inspected, said object being identifiable as a linear or band-like one, so that the object is determined as defective when the value of summation is below the given reference value.

Thus, if the luminance and the number of pixels of the image of the object to be inspected in its widthwise direction orthogonal to its longitudinal direction, wherein the object is identifiable as a linear or band-like one, are summated up, it is then possible to make inspection of defects very easily and very quickly. That is, when the object to be inspected is of constant quality, the summation of the luminance and the number of pixels of the object to be inspected in the widthwise direction becomes equal. When there is a defect, however, the value of summation of the luminance and the number of pixels in the widthwise direction becomes lower than a given reference value, because an image of a defective site becomes dark or its luminance or luminous intensity varies. In addition, the quantity of the data taken for defect inspection computation is so very small that processing can be implemented very easily and very fast, because that computation is the summation (integration) of the luminance and the number of pixels at a specific position (θ).

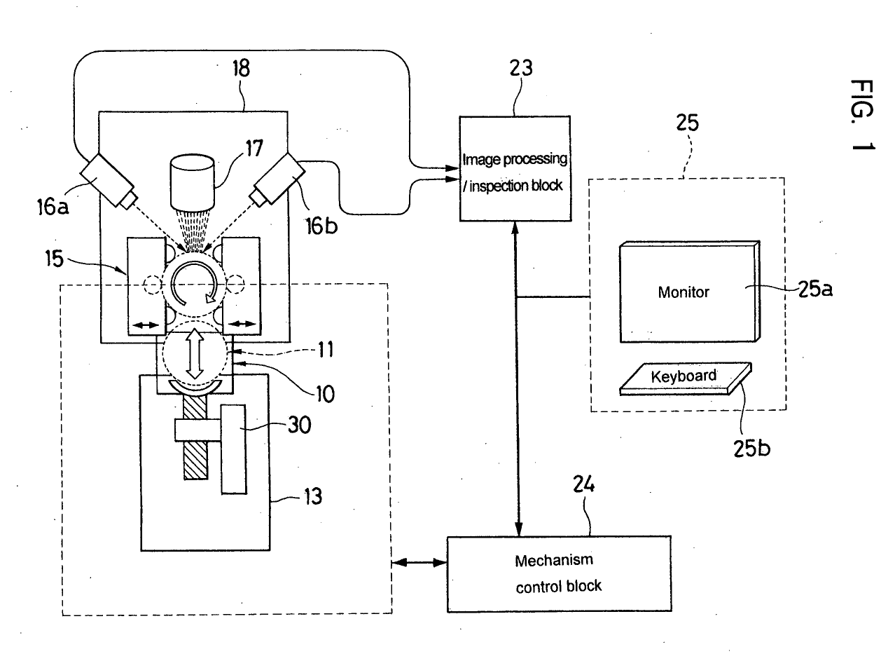

The defect inspection method of the present invention is now explained at great length with reference to the accompanying drawings. FIG. 1 is illustrative in schematic of the principles of the method according to the present invention. This embodiment is directed to the inspection of defects at an edge portion of a semiconductor wafer.

FIG. 1(A) is a schematic graph illustrative of an edge portion detected, wherein the x-axis is indicative of a distance from the position of the origin, and the O-axis is indicative of the quantity of rotation of a wafer disk, i.e., the position of the object to be inspected. Two curves e1 and e2 stand for edge ends of the semiconductor wafer, and an area surrounded by two such curves e1 and e2 defines the edge portion of the semiconductor wafer. Although the edge portion is on each surface of the semiconductor wafer, FIG. 1(A) shows the edge portion of one surface. An image pickup device is used to take an edge image of the edge portion while the semiconductor wafer disk is in rotation. As can be seen from FIG. 1(A), the edge image indicated by curves e1 and e2 vibrates under the influences of distortion in the disk.

At a certain position of rotation, now let LBl1 be a distance of the position of the origin to one edge end, Le1 be a distance between the curves e1 and e2, and Lbr1 be a distance from the other edge end to a reference position a. Then, at another position of rotation, let LBl2 be a distance from the position of the origin to one edge end, Le2 be the distance between the curves e1 and e2, and Lbr2 be a distance from the other edge end to the reference position a. Summation of the light quantity (luminance) of the picked-up image in the x-direction gives such a curve F(θ) as depicted in FIG. 1(B), wherein the L-axis is indicative of the summated light quantity (luminance), the θ-axis is the same as in FIG. 1(A), and s is indicative of an arbitrarily settable threshold value.

As can be seen from FIG. 1(A),

(1) in the case where there is no defect yet with vibration,
Le1≈Le2
Thus,
LBl1+Le1+Lbr1=LBl1+Le1+Lbr1=CONST
Therefore,
a
F(θ)=ΣX(θ)=CONST
X=0
wherein a is an arbitrarily set reference position. It follows that even when there are vibrations, the summated light quantity (luminance) in the x-axis direction at any site θ of the edge image portion is kept constant.

(2) In the case where there is a defect irrespective of vibrations,
Led<>Le1/Le2
Therefore,
F(θd)<>CONST
θd:Led
It follows that when there is a defect, the summated light quantity (luminance) in the x-axis direction at that site θ, i.e., the value of integration of the light quantity in the x-axis direction is not constant or variable. Usually, when there is a defect, the summated light quantity (luminance) decreases, as in FIG. 1(B). Here, if the threshold value is determined by multiplying the above constant value CONST by a given safety factor and the summated light quantity (luminance) F(θ), viz., F(θd) at a site lower than that threshold value is defected, then a defective site can be easily detected. Note here that depending on the defect to be detected, θ could be a specific point, a specific interval, or a specific infinitesimal interval.

Here, what is summated (integrated) for image judgment is the luminance or luminous intensity of the picked-up image of the object to be inspected in the widthwise (x-axis) direction. Usually, the luminance or luminous intensity in the widthwise (x-axis) direction is obtained from output signals of the image or light receptor of an image pickup device; it is obtained in the form of output signals commensurate with the luminance or luminous intensity for each pixel in the widthwise (x-axis) direction. Thus, the summated light quantity (luminance) in the widthwise (x-axis) direction of the image of the object to be inspected is obtained by multiplying the number of pixels in the widthwise (x-axis) direction by a signal value commensurate with the luminance or luminous intensity for each pixel.

Generally in the image processing art, computation for finding such a summated light quantity (luminance) is implemented on software using a processor, and so computation of enormous volumes of data such as image data must be implemented at all times; this indeed requires a much higher-level processor and other capabilities, and takes some considerable processing time. In the present invention, however, summation processing is needed for the light quantity of only a part of the image; it is not necessary to apply the computation processing to the whole image. Consequently, the amount of the data to be processed cannot only be much more reduced, but the computation processing can also be much faster in much simpler algorithm because it is simple in itself.

In the present invention, only the summation of output signals from the image pickup device is needed; a logic circuits combination such as a logic array may also be run on hardware without recourse to any processor. In this case, members capable of mechanical operation, such as a dip switch, a rotary switch and an encoder, may be used to determine the threshold value that provides a criterion of judgment; it is easy for the operator to select the threshold value with simple construction. In addition, such processing on hardware makes sure the processing is further sped up.

It is also possible to summate (compute) signals produced out of the image pickup device at an analog circuit. In this case, the threshold value that provides the criterion of judgment, too, may be provided in the form of analog signals such as voltage levels, which then enable an ordinarily used variable resistor or the like to be used for easy selection of the threshold value.

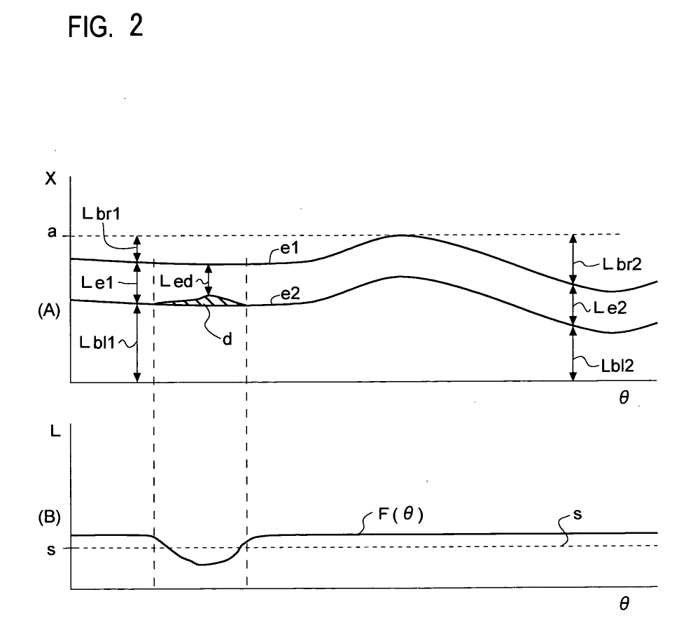

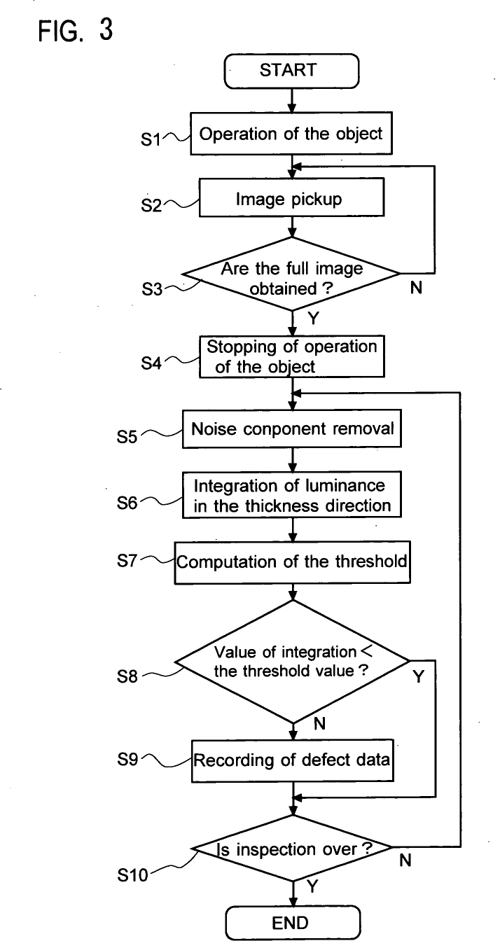

The inspection method of the present invention is now explained more specifically. FIGS. 2 and 3 are each a flowchart illustrative of the flow of processing in the method of the present invention.

First of all, when the object to be inspected is a semiconductor wafer, the semiconductor wafer is rotated (operated) so as to take its inspection image, for instance, the full image of its edge portion (S1). Then, while the object is in operation, the image of the portion to be inspected is picked up by means of an image pickup device (S2). By picking up the image of the site to be inspected while the object is in operation, it is thus possible to acquire the sequential images of the site to be inspected. And then, such image pickup operation is implemented until the full images of all sites to be inspected are obtained (S3).

Then, the operation of the object is stopped (S4), and the obtained image is processed. For an easy understanding of this processing, reference is now made to batch processing implemented after the acquisition of the full image; however, it may be implemented in real time. Even for real-time processing, however, it is preferable to acquire a certain sample data, as described later.

First, noise components are removed from the obtained image (S5). Specifically, pixels having a certain or lower luminance are factored out. An image having a certain or lower luminance, for the most part, comprises noise components, and if they are factored out, measurement precision is then much more improved. The level of removal of noise components may be easily derived from an empirical rule-based value. The noise level may vary or fluctuate depending on the state of the object to be inspected, the conditions of the system, etc., and so it is preferable for the operator to set a specific parameter freely as desired.

Then, the image of the processed image data concerning the object portion to be inspected is integrated with respect to the luminance in the thickness direction (S6). More specifically, luminance data for each pixel in the thickness direction are summated up.

Then, the threshold value is worked out by computation (S7). While it is preferable that the threshold value is automatically computed as will be described later, it may optionally be determined on the basis of an empirical rule or the like. Alternatively, the threshold value may be freely set by the operator as a parameter, as described above.

For automatic computation of the threshold value, some buildup of summation data on the object to be inspected is necessary. This is because a certain sample data are necessary for the purpose of offset removal, etc. in view of statistical processing for threshold value computation.

As depicted in the threshold value computation flowchart of FIG. 3, a non-inspection site for which inspection is not needed is first masked off (S11). This is because a semiconductor wafer or the like includes cutouts and recesses such as the so-called notches and orientation flats for the reason of precise alignment on the object to be inspected or other reasons. If such deformed sites are factored in, there will be a lot more chance of malfunction and errors.

Then, a direct-current component Dc is extracted from the obtained summated luminance data (S12). The direct-current component here means an offset of the summated luminance data, corresponding to the level of a straight line portion in the FIG. 1(B) graph. In other words, the direct-current component is defined by the level of the obtained summated luminance data that includes the highest proportion of the straight line portion.

Then, the area of a defective portion in the obtained summated luminance data is converted into a direct-current component Dd (S13). The defective portion here means a portion at a level lower than the above offset, and if this defective portion is extracted over a certain area and converted into a direct-current component, the level of the defective portion is then obtained. Note here that to what level the magnitude of a defect is set varies with the object to be inspected, the type of the defect to be detected, the desired precision, etc., and so it is preferable for the operator to set it arbitrarily as desired.

And then, the direct-current component Dd of the defective portion is excluded from the direct-current component Dc of the obtained normal area, so that the threshold value s is obtained: Dc−Dd=threshold value s (S15).

Then, the obtained threshold value (level) is compared with the summated data (level) at a specific position, so that when the summated data (level) are smaller than the threshold value (level), the object is determined as defective (S8).

When the object is judged as defective, defect data about the position, size, etc. of the defect are recorded (S9). Otherwise, this operation is spared. Finally, when two or more objects or sites are inspected, such as when two or more wafers received in a tray are inspected by one operation, whether or not all inspections are over is checked up. If not over, similar processing is resumed from the above noise component removal step (S5), and if over, the entire processing completes.

It is thus possible to detect defects in a nearly automatic fashion, and to implement the computation processing very fast because of its simplicity.

Such an algorithm as mentioned above could be achieved by a variety of software. For instance, this could be constructed by commercially available general-purpose software such as visual basic and C-language, and such software could be memorized in various memory media such as magnetic disks, e.g., flexible disks and hard disks; optical disks, e.g., CDs and DVDs; and semiconductor memories. And then, that software could not only be widely circulated through various delivery and distribution means, but it could also be sent and distributed by way of electronic communications means such as the Internet.

The most preferable system for carrying out the present invention is now explained with reference to the drawings.

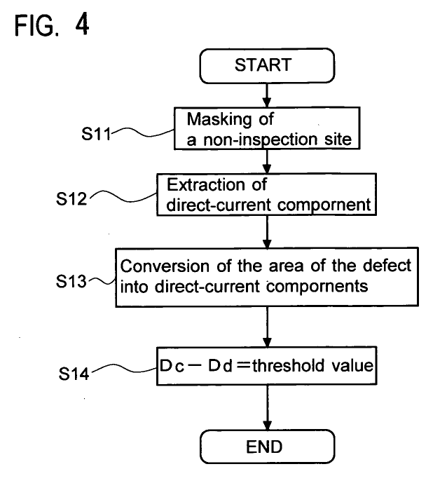

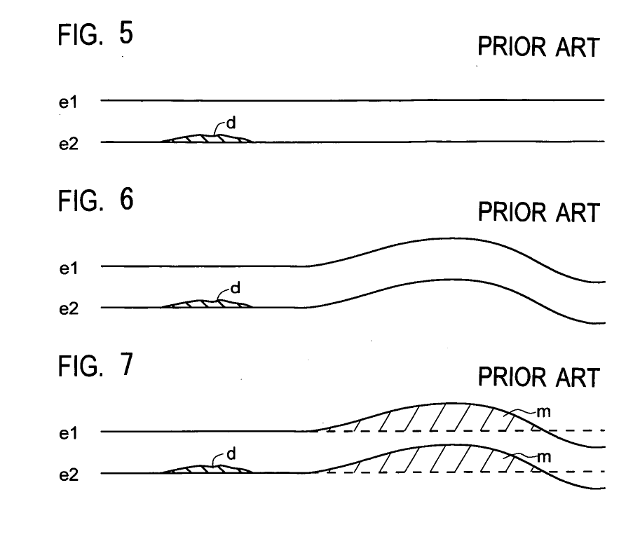

FIG. 4 is a block diagram representative of the basic arrangement of a semiconductor wafer inspection system adapted to carry out the present invention. In FIG. 4, the inspection system comprises a wafer pop-up unit 30 adapted to pop two or more wafers 11 from within a wafer storage container 10 up to an inspection block. Above the wafer pop-up unit 30, there is an inspection block 18 comprising a wafer holding/rotating section 15 adapted to hold together the wafers and rotate them together, image pickup devices 16a and 16b for taking images of wafer edge portions and an illuminator 18 adapted to direct taking light to the wafer edge portions. Images picked up by the image pickup devices 16a and 16b are processed at an image processing/inspection block 23 for making inspection of whether or not the wafers have defects at edges. For instance, the results are shown on a display device 25a in a man-machine control block 25. Further, there is a mechanism control block 24 provided for controlling the wafer pop-up unit 30, the wafer holding/rotating section 15, etc. in a comprehensive fashion.

The mechanism control block 24 works to control the wafer pop-up unit 30, the wafer holding/rotating section 15, etc. in a comprehensive manner. To this end, the block 24 comprises the circuit, processor, etc. that are necessary for driving and controlling a pulse motor and a servo motor, so that the image processing block 23 and the man-machine control block can be operated in response to operation commands and the progress of operation of each part while information is provided to them or received from them. The mechanism control block 24 could be independently constructed of a general-purpose control such as a sequencer or, alternatively, it could be integral with the above image processing/inspection block 23, using a general-purpose computer system such as a PC.

The man-machine operation block 25 works to communicate the system with the operator. Specifically, the block 25 comprises a display device 25a that is built up of various flat panel displays such as liquid crystal displays (LCDs) and ELs or displays using cathode ray tubes (CRTs), and an input device 25b such as a keyboard, a touch panel, a mouse or the like. These devices cooperate to display the results of inspection, images being processed, or internal data. In addition, it is possible to retrieve initial data, and transfer the accumulated data to other medium.

The wafer pop-up unit 30 works to pop up two or more wafers 11 together from within the storage container 10 positioned on an inspection table 13, and deliver them to the inspection block 18 positioned above. For the wafer pop-up unit 30, it is only needed to have a function of moving the wafers 11 in the storage container 10 from on the inspection table 13 to the position of the inspection block 18; however, it must make sure of some alignment precision at the position of the inspection block 18. To this end, it is acceptable to use a ball screw or the like that is driven by a serve motor or a pulse motor, each having given precision, or an air cylinder having an engagement positioning mechanism as an example.

The wafer holding/rotating section 15 works to hold two or more wafers 11 together and rotate them together. Specifically, on both sides of the inspection block, there are provided holder units, each comprising a pair of upper and lower rollers having a concavo-convex pattern configured to receive two or more wafers. At a time when the ascending wafer 11 arrives at the inspection block 18, the holder units advance toward the wafers for engagement with the above pair of rollers. Each roller, because of having a V-shaped concave portion, allows the wafers 11 to be forcedly positioned. Thus, the wafers 11 are positioned at four points in the circumferential direction and at four V-shaped grooves as well in the longitudinal direction, so that the wafers 11 can be positioned in place with very high precision. And then, by driving these rollers by a drive device capable of high-precision rotation control such as a pulse motor or a servo motor, two or more wafers can be rotated in a highly stable manner wile they are positioned with high accuracy.

Above the inspection block 18, there are the image pickup devices 16a and 16b located for taking the image of the edge of the wafer 11. Note here that the image of the wafer edge may be taken by either one of the image pickup devices 16a and 16b. To inspect an area of the wafer that lies centrally somewhat deep from the edge end, however, it is required to take an image of the wafer with some angle to the wafer plane; it is necessary to make inspections of both front and back sides of the wafer. Preferably to this end, there are the image pickup devices 16a and 16b provided for taking the images of the respective edge portions on the front and back sides, so that the images of both surfaces can be taken together for inspection.

The illuminator 17 disposed in the inspection block provides the light source necessary for taking the image of the wafer for inspection. To this end, a suitable selection may be made from incandescent lamps, fluorescent lamps, cold cathode tubes, LEDs, ELs, etc., all being generally used as light sources. For the illuminator 17, it is preferable to use one that emits a wavelength fit for edge defect inspection. Where to position the illuminator 17, and how many illuminators 17 are located may be optionally determined depending on the type, size and emission intensity of the illuminator 17, with inspection in mind.

The images picked up through the image pickup devices 16a and 16b are entered in the image processing/inspection block 23 having a capture function or the like, where they are converted into image data. Thereafter, the above inspection processing is implemented for defect inspection. The image data entered here, because of having been obtained from the images of the front- and back-side edge portions of two or more wafers, picked up while they are in rotation, take the form of linear or band-like image data twice as many as the wafers. Alternatively, indices such as orientation flats and notches are arranged in such a way as to be in alignment, so that batch mapping can be implemented on the basis of the index portions. Yet alternatively, on the basis of such indices, mapping may be implemented on software so that they can line up on the data. And then, such linear or band-like image data are processed by such a method as described above, so that when there is a defect found, the defect position can then immediately be identified on the above map. In addition, because the wafers contained in the storage container are all identified by where they are stored, a defect position of any of two or more wafers can be identified as objective position data.

The thus obtained defect data are memorized in a specific memory area in the inspection system, and they are managed, for instance, for each lot or per single storage container unit. If required, they may be stored in a memory medium such as an FD, CD or DVD, or they may be transmitted to other system such as a micro-inspector by direct communications. Alternatively, a wafer that is found to be defective is displayed on the display device (monitor) 25a of the man-machine operation block 25, so that it can be rejected after the completion of inspection. In this case, where that wafer lies in the storage container is identified; in other words, the defective wafer may be displayed on specific images of the wafers in the storage container.

It is thus possible to precisely identify the position of a defect on the object to be inspected in any space and at any time after the completion of inspection, with no need for the operation to memorize or mark defect positions one by one.

Semiconductor wafers can be processed by one operation while they are stored in a tray, and the method and system of the present invention can be applied to the defect inspection step at the image processing/inspection block, so that inspection processing can be implemented very fast with good precision.

With the defect inspection method of the present invention, very fast processing can be implemented by computation processing on software using this as an algorithm, and the influences of deformation of the object to be inspected can be factored out, so that defect inspection can be implemented with very high precision. In addition, there is a very broad range of applications, because, for processing, software cannot only be used but also combinations of gate elements or analog circuits can be employed.

Further, the present invention can be applied to inspection of not only semiconductor wafers but also every object in the form of a disk-like edge, for instance, hard disks and other memory media. Furthermore, the present invention could be applied to the inspection of objects such as fibers and electric wires, which are identifiable as linear or band-like images.

### ADVANTAGES OF THE INVENTION

According to the present invention, it is possible to provide a defect inspection method, and a defect inspection system, which enables an inspection time to be so very short that the operating time and tact time can be cut down, and in which the image to the object to be inspected is identifiable as a linear or band-like one.

It is also possible to provide a defect inspection method, and a defect inspection system, which prevents misidentification of the object to be inspected even when there is distortion or deformation, and can make precise defect inspection.

What we claim is:

1. A defect inspection method, comprising summation of a luminance and a number of pixels in a widthwise direction of an image of an object to be inspected, said image being identifiable as a linear or band-like one, wherein said object is determined as defective when a value of said summation is below a reference value.

2. The defect inspection method according to claim 1, wherein said object is an end of a disk.

3. A defect inspection system, wherein an image of an object to be inspected, which is identifiable as a linear or band-like one, is picked up, and a luminance and a number of pixels of the obtained image in a widthwise direction are summated up, so that said object is determined as defective when a value of said summation is below a given reference value.

4. A defect inspection program, which is adapted to implement processing comprising summation of a widthwise luminance and a widthwise number of pixels from image data about an object to be inspected, said object being identifiable as a linear or band-like one, wherein said object is determined as defective when a value of said summation is below a given reference value.

5. A memory medium, wherein the defect inspection program according to claim 4 is memorized.
